(19) United States
(12) Patent Application Publication
(10) Pub. No.: US 2016/0251499 A1
(43) Pub. Date: Sep. 1, 2016

(54) Process for Increasing the Adhesion of a Reinforcing Inorganic Material in a Polymeric Matrix, a Reinforcing Inorganic Material, a Process for Obtaining a Thermoplastic Composite Material, a Thermoplastic Composite Material, and a Thermoplastic Composite Article

(71) Applicant: UNIVERSIDADE FEDERAL DE SANTA CATARINA, Florianópolis - SC (BR)

(72) Inventors: Guilherme Mariz de Oliveira BARRA, Florianopolis (BR); Felipe Darbas RZATKI, Florianopolis (BR); Rafael Guntzel ARENHART, Florianopolis (BR); Aloisio Nelmo KLEIN, Florianopolis (BR); Roberto BINDER, Joinville (BR)

(21) Appl. No.: 15/033,269

(22) PCT Filed: Oct. 31, 2014
(86) PCT No.: PCT/BR2014/000396

§ 371 Date: Apr. 29, 2016

(30) Foreign Application Priority Data
Nov. 1, 2013 (BR) BR1020130282472

(51) Int. Cl. C08K 9/06; C09C 3/12

(52) U.S. Cl. CPC C08K 9/06; C09C 3/12

(57) ABSTRACT

Process for increasing the adhesion of a reinforcing inorganic material in an organic matrix: includes subjecting a dry load of particulate or fibrous reinforcing inorganic material presenting hydroxyls in its surface, to a first surface treatment with a coupling agent of the siloxane type containing amine groups, dissolved in an organic solvent free of water and with an acid pH and, after a curing step, to a new surface treatment with a coupling agent of the siloxane type dissolved in a solution containing an organic solvent and water, to be subjected to a new curing step. The reinforcement material may be mixed to a load of organic material defined by a polymer or by a monomer, to obtain a composite mixture to form a composite polymeric material which may present the desired final form or a raw form, to be ground or pelletized into a particulate form for posterior processing.

### FIELD OF THE INVENTION

The present invention refers to a process for treating reinforcing inorganic material, in the particulate or fibrous form, in order to increase the adhesion force thereof in a polymeric organic matrix, aiming to obtain a reinforcing inorganic material having increased adhesion capacity in a polymer matrix, in order to increase the mechanical strength of the latter.

The invention further refers to a process for obtaining a thermoplastic composite material, using said reinforcing inorganic material and to a composite material presenting suitable processability and which leads to the formation of composite components suitable for different applications, such as in hermetic compressors, which require certain resistance characteristics at a relatively reduced cost.

### BACKGROUND OF THE INVENTION

The most characteristic element of a certain polymeric material is the polymeric resin used. It is called resin the polymer itself, that is, the mass of long chains of covalent bonds connected to each other by means of weak bonds, said resin being the element which, in a more pronounced manner, determines the properties of the polymeric material.

On the other hand, the use of polymeric materials is not usually done with the polymeric resin in a pure state. Industrially, the polymeric resins are mixed to additives, loads and pigments, with the objective of adjusting the properties of the material to the specific requirements of the application desired for said material.

It is common, during development of a polymeric material, to employ significant effort in regard to additives, searching for new components or selecting appropriate additives and their ideal concentrations for a specific purpose.

The range of possibilities presented by the use of additives, loads and pigments, is of wide scope, and may generate from simple changes such as variation of the mechanical strength, color and processability, to more radical changes such as modification in the behavior of a polymer from flexible to rigid or from electrical insulating to conductive. In parallel, the use of loads is particularly relevant for reducing manufacturing and development costs of polymers.

In the development of reinforced polymeric materials, also called composite materials, the choices of resin, also called matrix, and of the additives are carried out in parallel and are correlated in the process, since it is possible to obtain optimized results by applying resins and additives in such a way that the limitations of one are compensated by the other.

One of the applications of reinforced polymers is related to high temperature conditions which, for the case of polymers, are usually considered temperatures slightly above ambient temperature, for example being possible to consider 100° C. as a high temperature. The low thermal resistance observed in polymers, when compared to that of ceramics and of metals, results from two distinct phenomena: thermal degradation of the polymeric chains and viscoelastic creep.

The thermal degradation of the polymeric chains, which is an organic material phenomenon, occurs by the breaking of the covalent bonds. This breaking implies in reducing the medium size of the polymer chain, as the covalent bonds suffer consecutive splits, reducing the mechanical properties of the material. Additionally, it may happen the loss of mechanical properties due to degradation or exudation of additives which are contained in the material, but this phenomenon depends on the additives used in the material, and cannot be generalized for all polymers. The second phenomenon is related to the viscoelastic properties of the polymers. Viscoelasticity is related to the fact of all materials behaving, under mechanical stress, as a sum of elastic responses (solid) and viscous (liquid). Polymers present higher susceptibility to the viscous part than metallic or ceramic materials, what makes possible the permanent deformation of the material, even under tensions below their yield strength (creep). This phenomenon is associated to the bonding forces between polymeric chains which, for being weak, make easy the relative motion between the chains.

As temperature increases, it may be observed an increase in the mobility of the polymeric chains and, consequently, the effect of creep becomes more evident. In such way, the variation of the mechanical properties of polymeric articles, as a function of the time or temperature, should be considered especially when the article is under constant mechanical stress, which situation becomes increasingly severe under high temperatures.

Both phenomen mentioned above are the main obstacles against using polymers under high temperatures: reduction of mechanical properties, caused by chain degradation, and the dimensional variation caused by viscoelastic creep.

A commonly used solution is using thermosets: polymers whose chains present cross links. This method makes the material resistant both to creep and to degradation. The creep is reduced because the cross linkings anchor the chains to each other, making difficult the relative displacement between them and thus avoiding the plastic deformation. The existence of cross links does not prevent the link breaking by the effect of thermal degradation. However, once the chains are interconnected by primary bonds, the average molecular weight of the chains is not significantly reduced. The thermal resistance assigned to cross links can be seen in the many polymers used in kitchenware. However, inherent limitations of the cross-polymers are: low processing versatility, high material rigidity.

Another solution found for using polymers in high temperature is using elastomers such as silicone. The bonds between oxygen atoms in the main chain are inherently more resistant and suffer a lower amount of breaking under high temperatures, while the cross links between chains, even if in a low concentration, make difficult the creep. Elastomers, however, are very flexible materials, with a low modulus of elasticity and therefore, even without considering the creep, do not present a dimensional stability.

Solutions comprising thermosets and elastomers respectively result in either too rigid or too flexible materials, making them inadequate for several applications such as, for example, in components for the discharge system of hermetic compressors, where it is necessary a high dimensional stability, but also a certain level of flexibility, all of that under a high temperature regime. In order to obtain a material with optimized intermediate properties, there were developed the thermoplastic resins for special use under high temperatures. However, these materials present a high cost, invalidating the use thereof on the above mentioned application.

The engineering thermoplastic resins present lower cost and thermo-mechanical properties than the resins for special use. However, their thermo-mechanical properties may be adjusted by incorporating different additives. Additives commonly associated with thermal applications are the foam-forming additives. These additives generate gas bubbles inside the polymer matrix in a certain processing stage, resulting in the expansion of the polymer into a foam. These foams provide high levels of thermal insulation, a desired property in components of the discharge system of hermetic compressors, but do not contribute in general to the thermal stability of the material. In order to improve the thermal stability of the polymer, the additive should somehow reinforce the structure of the polymer, in order to compensate the effects of degradation and inhibit the creep. Since the pores generated by the additives are hollow, they do not provide any structural contribution to the material.

A known solution for the lack of structural contribution of the pores formed by the additives is using hollow inorganic spherical particles. This additive acts as an artificial pore, increasing the thermal insulation, reducing density and reducing the material cost like a conventional pore, contributing to structuring the material due to its rigid walls. This contribution, however, demands good anchoring (adhesion) between matrix and load, which depends on the presence of chemical affinity between the spherical particle and the polymer matrix, and a large interface area between the two materials. None of these two conditions is present in this case, since usually there is no chemical affinity between inorganic particles and polymers, and the spherical format presents the lowest surface area possible for each volume unit among the geometric solids. In such way, the adhesion forces between the sphere and the material of the polymer matrix are weak and provoke a weakening of the material upon adding the spheres.

In turn, fibrous reinforcements present good anchoring due to their high morphological aspect ratio. However, this high aspect ratio also increases material rigidity, which may reach values even higher than those found in thermoset polymers. Additionally, for being dense materials, these fibers do not present the same potential for density reduction, increase of thermal insulation, cost reduction and processing versatility as presented by the hollow spheres, such characteristics being requirements for different applications such as, for example, those intended for the components of the discharge system of hermetic compressors.

Thus, in order to increase the anchoring of inorganic reinforcements without modifying the spherical geometry, it is necessary to improve the chemical affinity between the inorganic reinforcements and the organic matrix. One solution is to modify or replace the chemical groups which are present in the surface of the reinforcements. Bi-functional chemical compounds, such as silane agents, may present chemical affinity for the organic groups found in the polymer matrix and, simultaneously, for the hydroxyl groups, usually present in the surface of the spherical or fibrous inorganic reinforcements. Thus the incorporation of these compounds on the surface of inorganic reinforcements is commonly used in order to increase the chemical affinity between the reinforcement and the polymer matrix. However, simply modifying the surface of spherical inorganic reinforcements with a silane agent, despite improving anchoring, is still insufficient for solving the weakening of polymeric materials reinforced by inorganic spherical particles.

### OBJECTIVES OF THE INVENTION

Due to the different limitations inherent to the formation of composite materials and articles comprising a thermoplastic polymer matrix and particulate or fibrous inorganic reinforcements, the present invention has as one of its objectives to provide a treatment process applied to inorganic reinforcing materials, in order to increase their adhesion force in a polymeric organic matrix, aiming to obtain an inorganic reinforcing material having increased adhesion capacity in a polymer matrix, in order to increase the mechanical strength of the latter when incorporated thereto for forming different articles or components. Other objectives of the invention are providing a process for obtaining a thermoplastic composite material, using said reinforcing inorganic material, and providing a composition of a composite material presenting adequate processability and which allows to obtain thermoplastic composite articles having adequate cost, thermomechanical stability, mechanical strength and elasticity modulus for being used in hermetic compressors or any other applications which present similar requirements.

The application of said treatment in particulate inorganic reinforcements, which are incorporated in polymer matrixes after said treatment, in the production of composite materials and in the formation of composite articles, prevents the latter from becoming fragile, that is, prevents that the incorporation of particulate reinforcements in a polymer matrix reduces the tensile strength of the composite article to be formed.

Additionally, the application of said treatment in fibrous inorganic reinforcements to be then incorporated in a polymer matrix after said treatment, in. the production of composite materials and in the formation of composite articles, may increase the tensile strength of the material or article, as long as said fibrous inorganic reinforcement presents a length lower than the critical length.

The invention has the further objective to provide a material or composite article such as mentioned above and which further presents, as a function of the characteristics of the inorganic reinforcements being used, reduced density and thermal conductivity.

### SUMMARY OF THE INVENTION

One of the objectives above is achieved by means of a process for increasing the adhesion of a particulate or fibrous reinforcing inorganic material in a polymeric organic matrix, comprising the steps of: drying a load of particulate or fibrous reinforcing inorganic material, presenting hydroxyls in its surface and subjecting said load initially to a surface treatment with a dry solution of acid pH (free of water) of a coupling agent of the siloxane type containing amine groups, dissolved in and organic solvent; curing the treated material; subjecting it to a new surface treatment with at least one coupling agent of the siloxane type in a solution containing an organic solvent and water; and subjecting the load of inorganic material treated in the previous step to a new curing process.

A second objective of the invention is achieved by providing a particulate or fibrous reinforcing inorganic material, surrounded by a first surface layer of a first coupling agent of the siloxane type containing amine groups, anchored to the reinforcing inorganic material and surrounded by a second surface layer of a second coupling agent of the siloxane type, anchored in the first surface layer.

A third objective of the invention is achieved by providing a process for obtaining a thermoplastic composite material which initially comprises the step of subjecting a load, in dry condition, of a reinforcing inorganic material, presenting hydroxyls in its surface, to a surface treatment with a dry solution of acid pH (free of water) containing a coupling agent of the siloxane type containing amine groups dissolved in an organic solvent. Next, the inorganic material load is subjected to a new surface treatment with at least one coupling agent of the siloxane type dissolved in a solution containing an organic solvent and water, so that it can be mixed with a load of organic material selected from a polymer in a molten state or a monomer to be subsequently polymerized, in order to obtain a composite mixture respectively defined as polymeric or monomeric. After each step of surface treatment of the reinforcing inorganic material, the latter is subjected to a curing step.

The solidification of the polymeric composite mixture or the polymerization of the monomeric composite mixture allows the formation of a thermoplastic composite material in bulk.

Usually, the process defined above further includes the step of transforming the thermoplastic composite material in bulk into a particulate thermoplastic composite material in any of the formats defined by powders, pellets, billets and plates.

A fourth objective of the invention is achieved by providing a thermoplastic composite material having the composition characteristics defined, in a process for providing such characteristics as defined above.

A fifth objective of the invention is achieved by providing a thermoplastic composite article formed from molding, usually by extrusion or injection for particles and by thermoforming or machining for billets and plates, of the thermoplastic composite material defined above for the final form desired for the article.

The present invention, as briefly defined above in its different aspects, consists in providing a thermoplastic composite material having a characteristic of high mechanical strength, which is obtained by adding, to organic materials in the form of thermoplastic polymers or polymerizable monomers, additives of particulate or fibrous inorganic materials presenting hydroxyls in its surface. As mentioned in the state of the art discussion, despite adding fibers reduces the flexibility of the composite material, their incorporation increases the mechanical strength of the composite material in a more significant manner than incorporating particles. Therefore, the surface treatment in which this invention focuses may be carried out in fibrous particles to further increase the mechanical strength of composite materials, or the treatment may be carried out in particulate materials to avoid reducing the mechanical strength of the composite material.

Additionally, the present invention, as briefly defined above regarding its different aspects, consists in providing a thermoplastic composite material, having characteristics of high thermomechanical stability and low modulus of elasticity, obtained by adding, to organic materials in the form of thermoplastic polymers or of polymerizable monomers, additives of particulate inorganic materials presenting hydroxyls in its surface, for example, metallic material particles selected from: aluminum, boron, iron, titanium, nickel and tin, or also glass and/or ceramic spheres, preferably hollow.

This method allows increasing the thermomechanical stability, which is inherently low in polymeric materials, without compromising the characteristics of the polymer matrix such as flexibility, processing versatility and low cost.

Additionally, using hollow inorganic spheres allows reducing the density and the thermal conductivity of the material.

In such way, the present invention allows obtaining the benefits associated with the polymeric composites reinforced by spherical inorganic particles, particularly regarding: its dimensional stability under temperature conditions higher than ambient temperature; its reduced increase in rigidity when compared to the increase in rigidity provided by fibrous reinforcements; its thermal conductivity; its processing versatility; and its low cost, without compromising the tensile strength of the polymer matrix. This case is associated with the application of said composite material in hermetic compressors or in any other applications which present similar requirements.

### DESCRIPTION OF THE INVENTION

As already discussed in the present disclosure, there is the difficulty in obtaining composite materials having a organic matrix and inorganic reinforcement, presenting flexibility, good processing versatility, low thermal conductivity, low cost and also an adequate resistance to mechanical stresses, when operating in temperatures usually considered high for such type of matrix, such as the case, for example, in a hermetic compressor for refrigeration.

Said difficulty resides in the fact of providing an adequate amount of reinforcing material, which is simultaneously beneficial to an adequate mechanical strength, in certain operational conditions of relatively high temperature, without impairing the flexibility and the processability of the composite material.

Thus, an objective of the present invention is allowing the use of reinforcing materials in an amount which is beneficial to the increase of the mechanical and thermal resistances, without compromising the processability and the flexibility of the composite material in the formation of different machine articles or components.

In order to achieve the above mentioned objective, the invention provides a process for increasing the adhesion, in an organic matrix, of a reinforcing inorganic material, even with a morphology presenting low natural adherence to said organic matrix, such as the case, for example, with spherical particulate inorganic reinforcements.

The present treatment for increasing the adhesion comprises a initial step of drying a load of particulate or fibrous reinforcing inorganic material presenting hydroxyls in its surface, in order to eliminate humidity from said load, in order for said load to be able to be subjected, in this dry condition, to a surface treatment which comprises applying a non-aqueous acid solution (free of water) containing a coupling agent of the siloxane type, containing amine groups, dissolved in an organic solvent. The acid pH of the solution should be preferably maintained in the range from 2 to 5. The pH setting of the solution is preferably but not exclusively conducted by a carboxylic acid, such as for example acetic acid. After treatment in a solution, said load should be subjected to a curing step, in order to make strong bonds between the chemical compounds incorporated in the surface of the inorganic materials.

The drying step may be carried out by any method known in the art of drying materials, such as for example, but not exclusively, by ovens (natural or forced circulation or vacuum oven) and dissectors. The drying temperature should not exceed 300° C., preferably should not exceed 200° C., in order to avoid degradation of the hydroxyls groups present in the surface of inorganic materials. The drying time should be sufficiently long for removing all the water physically adsorbed on the surface of the reinforcing inorganic material.

As in the drying step, the curing step may be carried out by means of, for example, ovens (natural or forced circulation or vacuum oven) or by any other method known in the art which can maintain the inorganic reinforcing material heated, preferably to 120° C. from 1 to 12 horas. The curing step may also be carried out at ambient temperature, however the curing time increases up to 168 horas (1 week). A curing temperature higher than 150° C. may cause loss of the properties obtained with said surface treatment.

The first step of the surface treatment with the coupling agent must be carried out in a medium free of water and in an acid pH in order to inhibit the hydrolysis and condensation reactions of the siloxane compounds. In the present invention, using siloxanes containing amine groups, said conditions catalyze reactions between the amine groups present in the silanes of the coupling agent and the reinforcing inorganic material. As a result, it is obtained a reinforcing inorganic material having a surface with a high density of hydrolysable alkoxy groups. These alkoxy groups present low reactivity with organic compounds, that is, are not effective for the coupling between inorganic particles and polymeric matrixes. However, the alkoxy groups, likewise the hydroxyls, act as a site for the formation of primary bonds with new silane agents. Thus, the modification treatment described above, which includes applying an acid non-aqueous solution containing a coupling agent dissolved in an organic solvent, acts forming an intermediate layer which increases the concentration of sites for the subsequent incorporation of functional silanes as described below.

This first step of surface treatment may be carried out by any know method in the art for incorporating silanes in surfaces, such as, for example but not exclusively, through treatment via an acid non aqueous solution in bath or spray.

According to the description above, the present process for increasing the adhesion further includes the step of subjecting the load of inorganic material, after treatment with the non-aqueous acid solution, to a new surface treatment with at least one coupling agent of the siloxane type dissolved in a solution containing an organic solvent and water, and subsequently to a new curing step.

The concentration of water in said aqueous solution should be enough to promote the hydrolysis of all the alkoxy groups in the surface of the reinforcement, which are provided by the first treatment step, and of the alkoxy groups present in the silanes incorporated in the second treatment step. The hydrolysis process of the alkoxy groups leads to the formation of silanol groups. Silanol are highly reactive and react with each other in a condensation process.

The condensation process is characterized by the formation of primary bonds, that is, takes place a chemical anchoring by means of the formation of primary bonds between the layer provided in the first treatment step and the silanes incorporated in the second treatment step. Thus, the second treatment step forms a second surface layer over the intermediate layer formed during the first treatment step. Thus, the second step of modification treatment process described above, which includes applying an aqueous solution containing a dissolved coupling agent, acts forming a surface layer presenting a high concentration of functional groups having the ability of anchoring to polymeric organic matrixes. Additionally, the second step of the modification treatment process described above, which includes applying and aqueous solution, promotes hydrolysis and condensation reactions, leading to the formation of a web of strong primary bonds in the intermediate layer. This new surface treatment may be carried out by any method known in the art for incorporating silanes in surfaces such as, for example but not exclusively, through treatment via an acid non aqueous solution in bath or spray.

The layer formed over the inorganic material surface subjected to the treatment step with a non-aqueous acid solution, with the coupling agent and posteriorly crosslinked when subjected to the treatment step with an aqueous solution, acts as a transition region between the inorganic reinforcement having high rigidity (greater than 100 GPa) and the polymer matrix having low rigidity (less than 10 GPa). Moreover, said layer increases the mobility of the functional groups incorporated in the reinforcement material during the second treatment step and, as a consequence, leads to the formation of primary or secondary bonds with the thermoplastic organic matrix. The sum of the effects described above results in an increase of the adhesion forces between the reinforcing material and the thermoplastic matrix.

The coupling agents of the siloxane type used in the second surface treatment in aqueous medium should be selected in such a way that their organic functional groups promote the formation of primary or secondary bonds, preferably the formation of primary bonds with the thermoplastic polymer matrix.

The present process for increasing the adhesion is applicable in general to a particulate or fibrous inorganic material, and present hydroxyls in its surface. Suitable inorganic materials may be defined, for example, by a glass, such as a silicate or boron or aluminum silicate, or also a ceramic. The ceramic may be defined by oxides of aluminum, zirconium, boron, iron, titanium, nickel, tin and carbon.

Other inorganic materials presenting hydroxyls in their surfaces may be used as a reinforcement material, as is the case with metals: aluminum, boron, iron, titanium, nickel and tin.

One relevant aspect of the present process for increasing the adhesion results from the fact that it is particularly advantageous when applied to a particulate inorganic material defined by spheres, more particularly by hollow spheres, when it is desirable that the application to be given to the reinforcing material presents characteristics of low thermal conductivity.

In the case of using spheres, it is desirable that they present an average diameter between 1 and 100 μm and in the case of hollow spheres, it is preferable for them to present a diameter between 10 and 30 μm.

The invention further provides a particulate or fibrous reinforcing inorganic material, presenting hydroxyls in its surface and surrounded by a first surface layer of a first coupling agent of the siloxane type containing amine groups, anchored to the reinforcing inorganic material and surrounded by a second surface layer of a second coupling agent of the siloxane type anchored to the first surface layer.

It should be understood that both the inorganic material and the first and the second coupling agent present the same characteristics already previously described.

In function of the characteristics described hereinbefore, it may be observed that the reinforcing inorganic material is surrounded by a first surface layer with the first coupling agent of the siloxane type containing amine groups, anchored to the reinforcing inorganic material and surrounded by a second surface layer formed by the second coupling agent of the siloxane type, anchored to the first surface layer.

The invention further allows providing a process for obtaining a thermoplastic composite material by using a reinforcing inorganic material obtained according to the previously described process.

Thus, the process for obtaining the thermoplastic composite material comprises the steps of: drying a load of particulate or fibrous reinforcing inorganic material presenting hydroxyls in its surface; subjecting the load of dry inorganic material to a surface treatment with a solution of acid pH and dry (free of water), containing a coupling agent of the siloxane type containing amine groups dissolved in an organic solvent; subjecting the load of inorganic material treated in the previous step to a curing process; subjecting the load of inorganic material treated in the previous step to a new surface treatment with at least one coupling agent of the siloxane type dissolved in a solution containing one organic solvent and water; subjecting the load of inorganic material treated in the previous step to a new curing process; mixing the load of inorganic material treated in the previous step with a load of organic material selected from a polymer in a molten state and a monomer to be subsequently polymerized, in order to obtain a composite mixture defined between polymeric and monomeric; and forming a bulk thermoplastic composite material, from the solidification of the polymeric composite mixture and the polymerization of the monomeric composite mixture.

The process defined above may also include the step of transforming the bulk thermoplastic composite material into a particulate thermoplastic composite material in any of the forms defined by powders and pellets, or also transform the thermoplastic composite material into plates or billets.

It should be understood herein that both the inorganic material and the first and second coupling agent present the same characteristics already previously described in relation to the respective process of increasing the adhesion of said inorganic material.

In one of the forms of carrying out the process for obtaining the thermoplastic composite material in bulk, its organic matrix comprises at least on thermoplastic polymer of the type: polyolefin selected from polyethylene and polypropylene; polyamide; polycarbonate; polystyrene; polyacrylnitrile; polyoxyethylene; polyacetal; polysulfide; polysulfone; thermoplastic polyester selected from poly (butylene terephthalate) and poly (ethylene terephthalate); polyethyl acrylate; polymethylmetacrylate; a polyketone selected from poly (ether ether ketone), poly (ether imide), poly (amide imide); and thermoplastic fluoropolymer defined by polytetrafluoroethylene.

In case it is used poly(butylene terephthalate) as the thermoplastic polymer matrix to be mixed with hollow microspheres of borosylicate as the reinforcing material, the process for increasing the adhesion of the microspheres to the polymer matrix should use coupling agents of the siloxane type, provided with organic functions of the epoxy type.

In another form of carrying out the process, the thermoplastic composite polymeric material is obtained, in the final desired form, by the “in situ” polymerization of the composite mixture formed by the reinforcing inorganic material and by the organic material in the form of a monomer, either pure or in a solution, in the liquid state or viscous state.

Thus, the process may further comprise the formation of the thermoplastic composite material from a monomer to be polymerized in any physical form after its mixture with the reinforcing inorganic material, in order to produce a solidified composite. The resulting composite material may present the form of fine powders, which may be directly used in a molding process or may be subjected to a pelletizing process, to form pellets to be used in subsequent molding processes. In case the composite material resulting from the “in situ” polymerization presents the form of a bulk mass, it may then be subjected to a step of grinding into a particulate form, for subsequent processing into different forms and applications.

In the case of using a monomer to be mixed with reinforcing inorganic material before the polymerization step, the thermoplastic monomer may be of different types as long as they are adequate for the formation of the desired polymer matrix.

The organic matrix may comprise a monomer or a mixture of monomers which, when polymerized, results in a thermoplastic polymer of the type: polyolefin selected from polyethylene e polypropylene; polyamide; polycarbonate; polystyrene; polyacrylnitrile; polyoxyethylene; polyacetal; polysulfide; polysulfone; thermoplastic polyester selected from poly(butylene terephthalate) and poly(ethylene terephthalate); polyethylacrilate; polymethylmetacrylate; a polyketone selected from poly(ether ether ketone), poly(ether imide), poly(amide imide); and a thermoplastic fluoropolymer defined by polytetrafluoroethylene, or also a monomer or a mixture of monomers which, when polymerized, results in a thermofixed polymer of the type: polyepoxide; insaturated polyester; polyurethane; melamine resin; and formaldehyde urea resin.

The process for obtaining the thermoplastic composite polymeric material, such as defined above, is preferably carried out by using particulate inorganic reinforcements in the form of spheres presenting an average diameter between 1 and 100 μm, preferably an average diameter between 10 and 30 μm when in the form of hollow spheres, in order for the composite material to present an adequate combination between thermal insulation and thermomechanical stability. These effects compete against each other. The increase in the average diameter of the hollow spheres is favorable to the effect of thermal insulation. However, the effect of thermomechanical stability is favored by the reduction of the average diameter of the spheres. Additionally, either using spheres with a very large diameter (greater than 100 μm) or using spheres with very small diameter (smaller than 1 μm), impairs the processability of the composite.

Hollow inorganic particles are preferred for reducing the thermal conductivity and the density of the composite material to be obtained. In the case of hollow spherical particles, this geometric format tends to provide a better relation between the properties: thermal insulation, thermomechanical stability and mechanical strength. Hollow spherical particles having an average diameter between 10 e 30 μm are preferred.

In order to obtain composite material articles or components using the present process, it is desirable that the reinforcing inorganic material comprises from 20 to 60% in volume of the thermoplastic composite polymeric material, preferably between 40 e 60% in volume of spheres presenting an average diameter between 10 and 30 μm. Said thermoplastic composite material comprises, therefore, from to 80% in volume of organic material, and preferably from 40 to 60% in volume of the thermoplastic composite polymeric material.

With this composition, it is possible to obtain articles or components presenting processability, cost, thermomechanical stability, mechanical strength and modulus of elasticity adequate to be used in the discharge system of hermetic compressors and in other applications requiring similar characteristics.

The increase in the concentration of particles enhances the thermomechanical stability of the thermoplastic composite material. However, the increase in the concentration of particles leads to the reduction of the flexibility of the composite material. The upper limit in the concentration of particles is related to the percolation limit of the particles. Percolation limit is the concentration in which the average distance between the reinforcing particles tends to zero, thus leading to an excessive weakening of the composite polymeric material. The concentration limit for reinforcing particles is a function of the average size of the reinforcing particles, in which the reduction of the average diameter leads to the reduction of the concentration limit, in such a way that for a size of spherical particles having an average diameter of 20 μm, the concentration limit for particles is approximately 60%.

Depending on the characteristics of the conformation process of the article or component to be obtained in composite material, and also on the dimensional characteristics of the article or component, it may be desirable that the process for obtaining the composite material further comprises the step of adding, to the composite mixture, antioxidant additives defined from titanium or magnesium based particles.

Antioxidant additives, such as titanium or magnesium based particles, may be incorporated to the polymeric composite in order to prevent the oxidation of the polymer matrix and consequently increase the thermal stability of the composite during processing.

In one form of carrying out the process for obtaining the composite material as already mentioned, the step of mixing the load of reinforcing inorganic material, already with an increased amount of adhesion surface, with a load of organic material defined by a polymer in a molten state, further includes introducing an additive to be physically mixed with the molten organic material and with the reinforcing inorganic material dispersed in the organic matrix, in order to obtain an additivated composite mixture.

The step of mixing the organic, inorganic materials and additives may be carried out by any method known in the art of physical mixing of polymers such as, for example, but not exclusively, by means of internal mixers and extruders. The temperature of the mixture should be slightly higher than the fusion temperature of the thermoplastic polymer matrix, in order to reduce the degradation of the polymer, however providing and adequate viscosity for the mixing process.

The mixture time should be enough to adequately disperse the particles of reinforcing inorganic material in the thermoplastic polymer matrix. Long mixing times potentiate the degradation of the polymer matrix and, consequently, deteriorate the properties of the composite material to be obtained. In such way, mixing times longer than 30 minutes should be avoided.

Another already described way of carrying out the process for obtaining the composite material includes the step of mixing the load of reinforcing inorganic material, already with a higher amount of adhesion surface, with a load of organic material defined by a monomer, either pure or in a solution, in the liquid state or viscous state, in order to obtain a composite mixture to be polymerized “in situ” already in the final form of the article or component to be obtained or in any other raw form to be posteriorly ground to form a particulate composite material for further processing, or also in the form of fine powders, which can be directly used in a molding process, or submitted to a pelletizing process for generating pellets to be used in posterior molding processes. In this process alternative, the additives are physically mixed with the liquid organic material and with the reinforcing inorganic material dispersed in the organic matrix, in the moment of the “in situ” polymerization.

As already mentioned, the contribution of particulate reinforcing materials to the mechanical strength of composite materials requires a good anchoring between the matrix and the reinforcement material, which depends on the adhesion forces and on the interface area between the particulate reinforcing material and the matrix. None of these two conditions is present when inorganic spherical particles are incorporated in polymeric matrixes, leading to the weakening of the composite material obtained. The present invention presents a technical solution for surface modification, which is applicable to inorganic substrates and which is able to increase the adhesion force between inorganic particles and polymeric matrixes. This technique makes possible to use the composite material reinforced by particles with a morphological aspect ratio close to 1 in applications in which mechanical strength is necessary.

1. A process for increasing the adhesion of a reinforcing inorganic material in a polymeric matrix, characterized in that it comprises the steps of:
drying a load of reinforcing inorganic material, particulate or fibrous and presenting hydroxyls in its surface;
subjecting the load of dry inorganic material to a surface treatment, with a solution presenting acid pH and dry (free of water) , containing a coupling agent of siloxane type, containing amine groups, dissolved in an organic solvent;
subjecting the load of inorganic material treated in the previous step to a curing process;
subjecting the load of inorganic material treated in the previous step to a new surface treatment with at least one coupling agent of the siloxane type dissolved in a solution containing an organic solvent and water; and
subjecting the load of inorganic material treated in the previous step to a new curing process.

2. The process, as set forth in claim 1, characterized in that the particulate or fibrous inorganic material is defined from at least one of the materials glass, ceramic and metal.

3. The process, as set forth in claim 2, characterized in that the glass is defined from a silicate or a borosilicate, the ceramic is defined from an oxide of aluminum, zirconium, boron, iron, titanium, nickel, tin and carbon and the metal is defined from aluminum, zirconium, boron, iron, titanium, nickel and tin.

4. The process, as set forth in claim 1, characterized in that the particulate inorganic material is defined by spheres.

5. The process, as set forth in claim 4, characterized in that the spheres are hollow.

6. The process, as set forth in claim 5, characterized in that the hollow spheres present a diameter between 10 and 30 μm.

7. The process, as set forth in claim 4, characterized in that the reinforcing inorganic material comprises spheres having an average diameter between 1 and 100 pm.

8. A reinforcing inorganic, material, particulate or fibrous, characterized in that it presents hydroxyls in its surface and is surrounded by a first surface layer of a first coupling agent of the siloxane type containing amine groups, anchored to the reinforcing inorganic material and surrounded by a second surface layer of a second coupling agent of the siloxane type, anchored in the first surface layer.

9. The material, as set forth in claim 8, characterized in that the particulate or fibrous inorganic material is defined from at least one of the materials glass, ceramic and metal.

10. The material, as set forth in claim 9, characterized in that the glass is defined from a silicate or a borosilicate, the ceramic is defined from an oxide of aluminum, zirconium, boron, iron, titanium, nickel, tin or carbon and the metal is defined from aluminum, zirconium, boron, iron, titanium, nickel or tin.

11. The material, as set forth in claim 8, characterized in that the particulate inorganic material is defined by spheres.

12. The material, as set forth in claim 11, characterized in that the spheres are hollow.

13. The material, as set forth in claim 12, characterized in that the hollow spheres present a diameter between 10 and 30 μm.

14. The material, as set forth in claim 11, characterized in that the reinforcing inorganic material comprises spheres having an average diameter between 1 e 100 μm.

15. A process for obtaining a thermoplastic composite material by using a reinforcing inorganic material obtained according to the process defined in claim 1, characterized in that it comprises the steps of:
mixing a load of the inorganic material with a load of organic material selected from a polymer in a molten state or a monomer to be posteriorly polymerized, in order to obtain a composite mixture defined from polymeric or monomeric; and forming the thermoplastic composite material in bulk, from one of the operations of: solidifying a polymeric composite mixture; and polymerizing the monomeric composite mixture.

16. The process, as set forth in claim 15, characterized in that it further includes a step of transforming the bulk thermoplastic composite material into a particulate thermoplastic composite material in any of the forms defined by powders, pellets, plates and billets.

17. The process, as set forth in claim 15, characterized in that the organic matrix comprises at least on thermoplastic polymer of the type: polyolefin selected from polyethylene and polypropylene; polyamide; polycarbonate; polystyrene; polyacrylnitrile; polyoxyethylene; polyacetal; polysulfide; polysulfone; a thermoplastic polyester selected from poly (butylene terephthalate) and poly (ethylene terephthalate); polyethylacrilate; polymethylmetacrylate; a polyketone selected from poly (ether ether ketone), poly (ether imide) , poly (amide imide); and a thermoplastic fluoropolymer defined by polytetrafluorethylene.

18. The process, as set forth in claim 15, characterized in that the organic matrix comprises a monomer, or a mixture of monomers which, when polymerized, results in a thermoplastic polymer of the type: polyolefin selected from polyethylene and polypropylene; polyamide; polycarbonate; polystyrene; polyacrylnitrile; polyoxyethylene; polyacetal; polysulfide; polysulfone; a thermoplastic. polyester selected from poly (butylene terephthalate) and poly (ethylene terephthalate); polyethylacrilate; polymethylmetacrylate; a polyketone selected from poly (ether ether ketone), poly (ether imide) , poly (amide imide); and a thermoplastic fluoropolymer defined by polytetrafluorethylene, or also a monomer, or a mixture of monomers which, when polymerized, results in a thermoset polymer of the type: polyepoxide; unsaturated polyester; polyurethane; melamine resin; and formaldehyde urea resin.

19. The process, as set forth in claim 15, characterized in that the reinforcing inorganic material comprises from 20 to 60% in volume of the composite polymeric material, preferably between 40 and 60% in volume of spheres presenting an average diameter between 10 and 30 μm and that the composite polymeric material comprises from 40 to 80% in volume of organic material, preferably from 40 to 60% in volume of the composite polymeric material.

20. The process, as set forth in claim 15, characterized in that it comprises the step of adding to the composite mixture antioxidant additives defined from magnesium or titanium-based particles.

21. A thermoplastic composite material, in the form of a material in bulk, particulate or pelletized and comprising the reinforcing inorganic material such as defined in claim 8, characterized in that it further comprises a matrix of polymeric organic material in which is dispersed the reinforcing inorganic material, with the layer of the second coupling agent of the reinforcing inorganic material anchoring the layer, of the first coupling agent in the organic matrix.

22. The material, as set forth in claim 21, characterized in that the organic matrix comprises at least one thermoplastic polymer of the type: polyolefin selected from polyethylene and polypropylene; polyamide; polycarbonate; polystyrene; polyacrylnitrile; polyoxyethylene; polyacetal; polysulfide; polysulfone; a thermoplastic polyester selected from poly (butylene terephthalat) and poly (ethylene terephthalate); polyethylacrilate; polymethylmetacrylate; a polyketone selected from poly (ether ether ketone), poly (ether imide), poly (amide imide) ; and a thermoplastic fluoropolymer defined by polytetrafluorethylene.

23. The material, as set forth in claim 21, characterized in that the organic matrix comprises a monomer, or a mixture of monomers which, when polymerized, results in a thermoplastic polymer of the type: polyolefin selected from polyethylene and polypropylene; polyamide; polycarbonate; polystyrene; polyacrylnitrile; polyoxyethylene; polyacetal; polysulfide; polysulfone; a thermoplastic polyester selected from poly (butylene terephthalate) and poly (ethylene terephthalate); polyethylacrilate; polymethylmetacrylate; a polyketone selected from poly (ether ether ketone), poly(ether imide), poly (amide imide); and a thermoplastic fluoropolymer defined by polytetrafluorethylene, or also a monomer, or a mixture of monomers which, when polymerized, results in a thermoset polymer of the type: polyepoxide; unsaturated polyester; polyurethane; melamine resin; and formaldehyde urea resin.

24. The material, as set forth in claim 21, characterized in that the reinforcing inorganic material comprises from 20 to 60% in volume of the composite polymeric material, preferably between 40 and 60% in volume of spheres presenting an average diameter between 10 and 30 μm and that the composite polymeric material comprises from 40 to 80% in volume of organic material, preferably from 40 to 60% in volume of the composite polymeric material.

25. The material, as set forth in claim 21, characterized in that it comprises antioxidant additives defined from magnesium or titanium-based particles.

26. A thermoplastic composite article, characterized in that it is defined by molding the thermoplastic composite material defined in claim 20.
